(19) United States
(12) Patent Application Publication
(10) Pub. No.: US 2002/0067699 A1
(43) Pub. Date: Jun. 6, 2002

(54) Communication method for connecting two communication parties to each other by means of a point-to-point connection

(75) Inventors: Klaus-Dieter Renner, Nuernberg (DE); Ulrich Rother, Moehrendorf (DE)

Correspondence Address: BAKER BOTTS LLP, 44TH FLOOR, 30 ROCKEFELLER PLAZA, NEW YORK, NY, 10112-4498, US

(73) Assignee: SIEMENS AG

(21) Appl. No.: 09/867,873

(22) Filed: May 30, 2001

(30) Foreign Application Priority Data
May 31, 2000 (DE) 100 268 12.9
Jul. 24, 2000 (DE) 100 359 86.8

(51) Int. Cl. H04L 12/26; H04J 3/14

(52) U.S. Cl. 370/252; 370/260

(57) ABSTRACT

A communication method for two communication parties linked to each other by means of a full-duplex point-to-point connection is disclosed. According to the present invention, this method is subdivided into an identification phase, a configuration phase and a data exchange phase, the communication parties identifying themselves to one another and defining their communication parameters during the identification phase, communication-party-dependent configuration data being exchanged between the two communication parties during the configuration phase, and cyclical and acyclical data being exchanged between the two communication parties during the data exchange phase if the configuration phase has been successfully completed. A fast periodic communication between two parties is consequently obtained, where no dual-port RAMs are required, with the result that this method is particularly cost-effective.

### FIELD OF THE INVENTION

The invention relates to a communication method for linking two communication parties to each other by means of a full-duplex point-to-point connection.

### BACKGROUND OF THE INVENTION

Converter devices linked to option modules by means of a parallel interface via a dual-port RAM are commercially available. These option modules are communication modules, also referred to as automation modules and technology modules. These option modules are fitted in an electronics box of a converter device. The data exchange takes place via the dual-port RAM. The data comprises configuration data, cyclical data (process data) and acyclical data (parameters).

Instead of accommodating these option modules in an electronics box, alternatively these option modules may be fit onto the SUB-D jack present on the front side of a converter device. In this alternative arrangement, the data exchange also takes place by means of a parallel interface via a dual-port RAM.

These dual-port RAMs used for the data exchange are relatively expensive. In the case of a converter device, with low performance requirements, the price of the dual-port RAM becomes significant. The parallel interface requires many lines, predetermining the size of a SUB-D jack. Furthermore, this connection is susceptible to interference. Due to this interference susceptibility, the lines must have a short line length.

For the communication, several protocols are also available, such as USS, PROFIBUS or SIMATIC S7. USS and PROFIBUS are master-slave protocols, which have no mechanism for an asymmetrical communication in both directions. In short, only the master can start an inquiry, the slave only being capable of responding to it. Furthermore, these standard protocols have many functionalities which are not necessary in the case of communication between a converter and an option module. This excessive functionality of the standard protocols leads to reduced speed and reduced bandwidth of the data transmission. By contrast with the first two protocols mentioned, the SIMATIC S7 protocol has no mechanism for a symmetrical data transmission.

Thus, there is a need for a more efficient and cost effective communication system.

### SUMMARY OF THE INVENTION

The present invention provides a communication method where the communication parties identify themselves to one another during a starting procedure and exchange their capabilities and communication properties. The best possible configuration, which makes optimum use of the available bandwidth, is then automatically chosen from these capabilities and properties. As a result, the communication mechanism is scalable, allowing option modules to be exchanged between converters of differing performance. Furthermore, the communication is independent of the configuration of the option modules.

The communication properties which are exchanged during the starting procedure include, but are not limited to, the type of communication (synchronous/asynchronous); greatest supported baud rate; cycle time; quantity of configuration data; quantity of cyclical data; and quantity of acyclical data.

With the aid of these exchanged communication properties, the best possible configuration can be automatically chosen.

In the case of an advantageous method, the identification phase is preceded by an initialization phase, with which the second communication party is detected by the first communication party. For the identification of the second communication party, a voltage potential on a connecting line is evaluated. In the simplest way, the evaluation takes place with a table in which the voltage values of all the option modules which can be connected to a converter are stored. An initialization phase of this type is provided whenever the first communication party is intended to communicate with all possible option modules without an operator.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 illustrates a general diagram showing the possible connections between a converter and various option modules in accordance with an exemplary embodiment of the present invention;

FIG. 2 illustrates a parallel topology with a connected automation module and a technology module in accordance with an exemplary embodiment of the present invention;

FIG. 3 illustrates the serial topology of an automation module and a technology module in accordance with an exemplary embodiment of the present invention;

FIG. 4 illustrates an overview of the phases of the method in accordance with an exemplary embodiment of the present invention;

FIG. 5 is a table illustrating the transmission sequence of the messages of the identification phase in accordance with an exemplary embodiment of the present invention;

FIGS. 6 and 7 each schematically illustrate the mode of operation of the master and slave during the identification phase in accordance with an exemplary embodiment of the present invention;

FIG. 8 is a table illustrating the transmission sequence of the messages of the configuration phase in accordance with an exemplary embodiment of the present invention;

FIGS. 9 and 10 each schematically illustrate the mode of operation of the master and slave during the configuration phase in accordance with an exemplary embodiment of the present invention;

FIG. 11 is a table illustrating the transmission sequence of the messages of a data exchange phase with alternating cyclical/acyclical data in accordance with an exemplary embodiment of the present invention;

FIG. 12 illustrates the mode of operation of the master and of the slave during the data exchange phase in accordance with an exemplary embodiment of the present invention;

FIG. 13 is a table illustrating the transmission sequence of the messages for the acyclical data exchange without any domain handling in accordance with an exemplary embodiment of the present invention;

FIGS. 14 and 15 each illustrate the acyclical mode of operation without the domain of the client and server in accordance with an exemplary embodiment of the present invention;

FIG. 16 is a table illustrating the transmission sequence of the messages for the acyclical data exchange with domain handling in accordance with an exemplary embodiment of the present invention;

FIG. 17 illustrates the acyclical mode of operation of the client with domain transfer in accordance with an exemplary embodiment of the present invention; and

FIG. 18 illustrates the acyclical mode of operation of the server with domain transfer in accordance with an exemplary embodiment of the present invention.

### DETAILED DESCRIPTION OF THE INVENTION

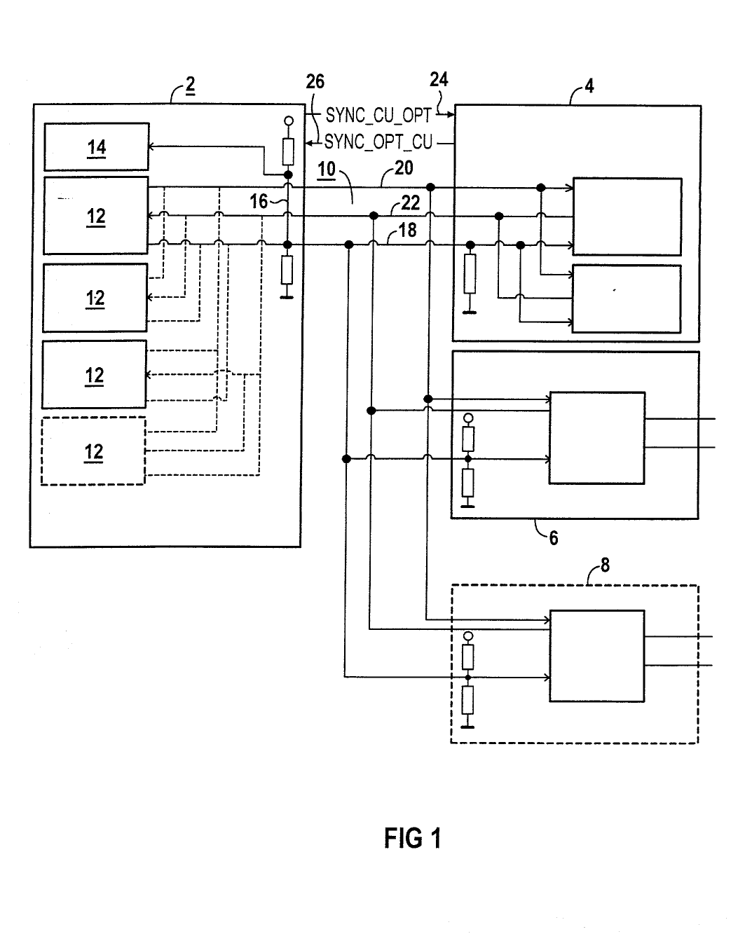

Now referring to the drawings, FIG. 1 illustrates a system wherein a first communication party is denoted by 2 and a second communication party is respectively denoted by 4, 6, 8. Of these second communication parties 4, 6, 8, only one is linked to the first communication party 2 by means of a full-duplex point-to-point connection 10. Represented as the first communication party 2, in drive engineering by way of example, is a current converter device of a drive system, of which only the controller comprising a processor is illustrated in FIG. 1. Normally, the processor of the communication party has only one interface 12. However, alternatively there can be a plurality of interfaces 12, which can be enabled. This enabling is accomplished by an initialization phase. For this purpose, an A/D converter 14 with a voltage divider 16 is provided.

Illustrated in FIG. 1, as the second communication parties 4, 6 and 8, are a technology module 4, an interface module 6, which is also referred to as an automation module, and a rotational speed measuring module 8. These modules 4, 6 and 8 do not constitute a conclusive list, but are instead intended to show exemplary variations of the modules which can communicate with the first communication party (drive system) 2 by means of the full-duplex point-to-point connection 10.

For the communication, the full-duplex point-to-point connection 10 requires three lines. One line 16 for the transmission of a clock signal (CLK), one line 18 for the transmission of data (Tx) and one line 20 for the reception of data (Rx). On the line 16, a clock signal CLK is transmitted if a synchronous connection takes place and/or a module identification takes place during the starting procedure. This signal CLK is not required in the case of an asynchronous connection. A signal TXE is transmitted on this line 16 as soon as a transmitter-receiver module is used as the second communication party 4, 6, or 8. In addition, two further lines 22 and 24 may also be provided, but are not required for the communication. By means of these two lines 22 and 24, synchronization signals SYNC₁₃CU₁₃OPT and SYNC₁₃OPT₁₃CU are transmitted. By means of the synchronization signal SYNC₁₃CU₁₃OPT, a technology module 4 is synchronized to the processor of a current converter device 2 and, by means of the synchronization signal SYNC₁₃OPT₁₃CU, the processor of a current converter device 2 is synchronized to a technology module 4.

It can be seen from the individual modules 4, 6 and 8 that line 16, with which a clock signal CLK is transmitted, is connected to different voltages. In this exemplary embodiment, the technology module 4 generates a voltage level of 1 V on line 16, whereas the rotational speed measuring module 8 generates a voltage level of 3.5 V on line 16. The automation module 6 generates different voltage levels, depending on its interface characteristics. If the automation module 6 is designed as an RS232 interface, the voltage level on line 16 has a value of 1.5 V. If, on the other hand, the automation module 6 is designed as an RS485 interface or as a PROFIBUS interface, the voltage level on line 16 has a value of 2 V or 3 V. Dependent on this differing voltage level, the second communication party 4, 6, 8 can be identified by the first communication party 2 during the communication starting procedure. This identification of the second communication party 4, 6, 8 only takes place if the first communication party 2 is equipped for all possible second communication parties 4, 6, 8.

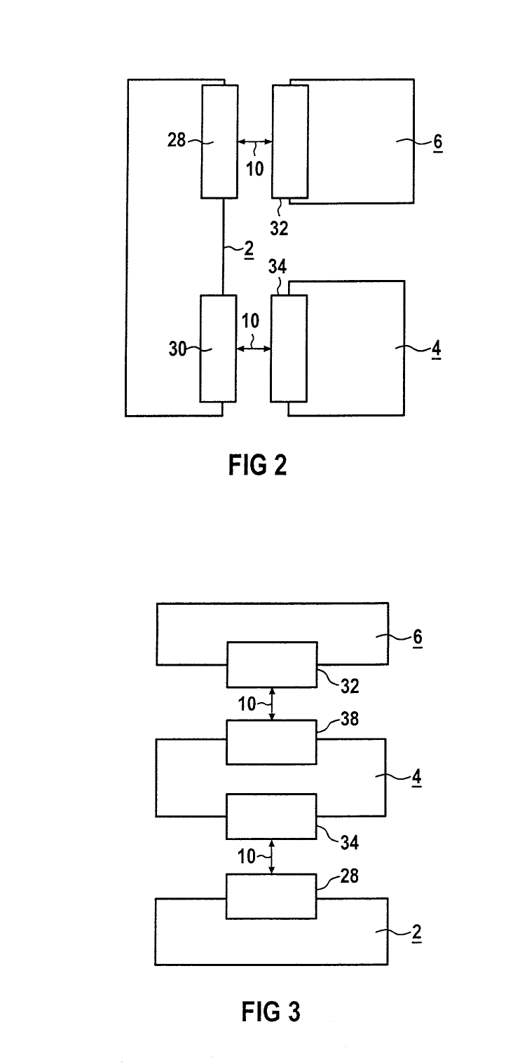

In FIGS. 2 and 3, two topologies of an automation module 6 and a technology module 4 are illustrated. The topologies shown are a parallel topology (FIG. 2) and a serial topology (FIG. 3). In the case of the parallel topology, both modules 4 and 6 are connected in parallel with a first communication party 2, e.g., a current converter device. For this purpose, the first communication party 2 must have two interfaces 28 and 30. The interfaces 28 and 30 are each linked by means of a full-duplex point-to-point connection 10 to an interface 32 and 34, of the automation module 6 and of the technology module 4, respectively. In the case of the serial topology, the technology module 4 is connected to the first communication party 2 and the automation module 6 is connected to the technology module 4. For this serial topology, the technology module 4 requires two interfaces 34 and 38. The interfaces 34 and 38 are connected by means of a full-duplex point-to-point connection 10 to an interface 28 and 32, respectively, of the first communication party 2 and of the automation module 6, respectively. The two topologies differ not only in the hardware, but also in the process data transmission. In the case of the parallel topology, the process data is transmitted from the automation module 6 to the first communication party 2 and then from the latter to the technology module 4. In the case of the serial topology, the process data is transmitted directly from the automation module 6 to the technology module 4 and from the technology module 4 to the first communication party 2. As a result, the parallel topology has a longer dead time in the process data transmission than the serial topology. The mentioned interfaces 28, 30, 32, 34 and 38 are serial interfaces. In this exemplary embodiment, where the first communication party 2 is a current converter device of a drive system, the processor has only one serial interface. Consequently, the serial topology is appropriate for a current converter device of a drive system.

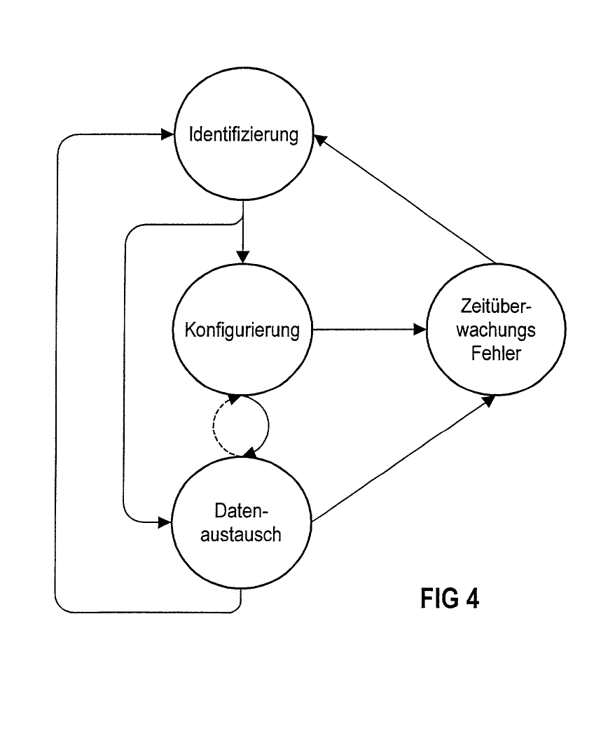

FIG. 4 illustrates the phases of the method according to the present invention for two communication parties 2, and 4 or 6 or 8, which are linked to each other by means of a full-duplex point-to-point connection 10. The method according to the present invention has three phases, namely the identification phase, the configuration phase and the data exchange phase. In an advantageous embodiment, the identification phase is preceded by an initialization phase. If the configuration phase is not required, the identification phase is coupled directly to the data transmission phase. If the communication connection is defective during the communication, this connection is restored by re-starting the identification phase.

During the identification phase, the two communication parties 2, and 4 or 6 or 8 identify themselves to one another and define their communication parameters. If there is a configuration phase, this follows on from the identification phase. During this configuration phase, module-dependent configuration properties are exchanged between the communication parties. These exchanged communication properties include but are not limited to type of communication (synchronous/asynchronous); greatest supported baud rate; cycle time; quantity of configuration data; quantity of cyclical data; and quantity of acyclical data.

The best possible configuration, which makes optimum use of the available bandwidth, is then automatically chosen from these communication parameters and communication properties. Once the best possible configuration has been selected, the data exchange can begin.

The data exchange phase has up to three channels comprising one cyclical channel and two acyclical channels. The cyclical channel or the acyclical channels do not have to be present simultaneously. However, at least one channel must be present for a data transmission. These channels are transmitted serially per clock period of the first communication party 2. Between two channels there is in each case a pause for a predetermined time, in which the clock signal CLK is not active. This predetermined time is set such that two data words can be transmitted. This time is necessary for the second communication party 4 or 6 or 8 to process the received message, comprising a frame and data, and reset its receive section to the beginning for the next message. Process data is transmitted with the cyclical channel, and parameters are transmitted with the acyclical channels. These parameters also include error and diagnosis parameters. The number of cyclical and acyclical channels determines the time which is needed to transmit a channel. In the identification and configuration phases there is in each case only one channel, referred to as the identification or configuration channel, respectively.

With this definition, according to the present invention, scalability is achieved, so that the modules are exchangeable between communication parties 2 of differing power levels. For example, in drive engineering, one and the same module can be linked to a base-current converter device, a vector-current converter device or a high-performance current converter device without having to change the communication mechanisms. As a result, the diversity of a module is reduced to one configuration, whereby the costs can be significantly reduced and whereby modules can also be used in the base-current converter devices.

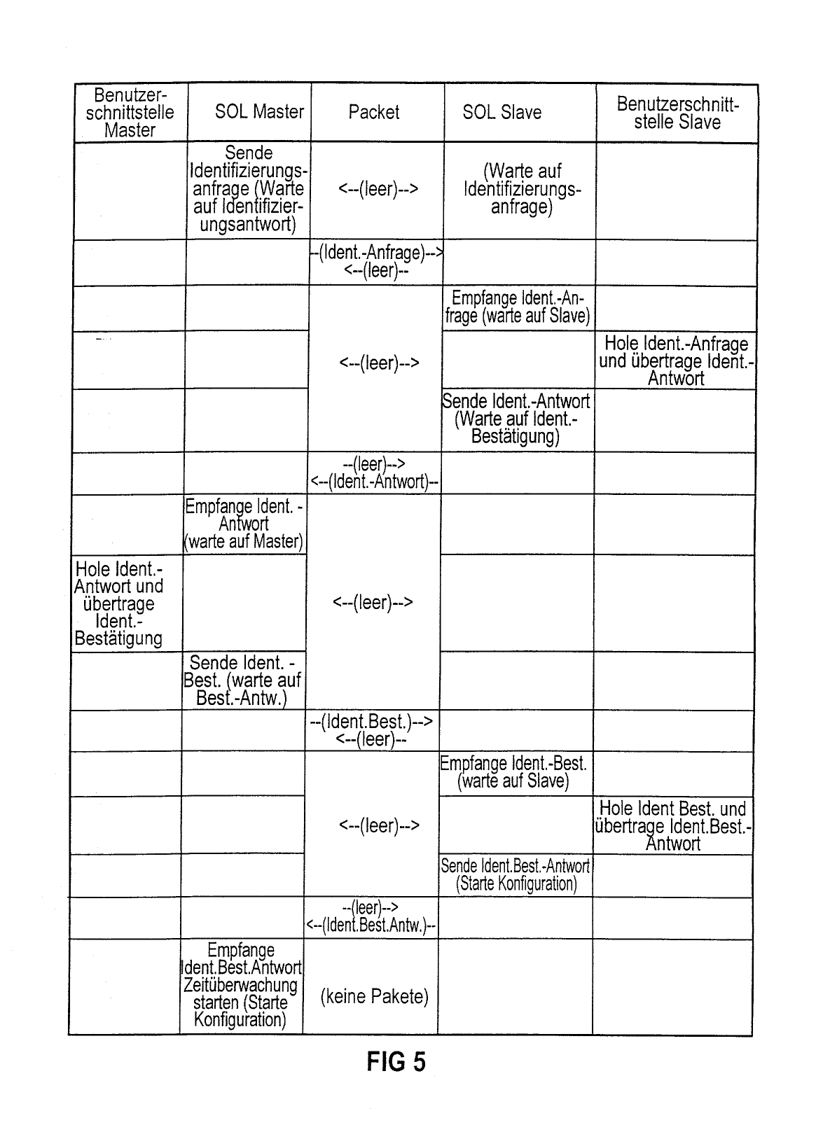

FIG. 5 illustrates a table showing the transmission sequence of the messages in the identification phase of the communication method according to the present invention. As already mentioned, the two communication parties 2, and 4 or 6 or 8 identify themselves to one another during the identification phase. This identification phase is repeatable, i.e. it can be restarted without switching the power supply of the first communication party 2 off and on again. In this identification phase, four messages are transmitted, referred to as follows:

ident.req. : identification request

ident.rep. : identification reply

ident.ack. : identification acknowledgement

ident.arep.: identification acknowledgement reply.

During the identification phase, the baud rate is set to 5k baud and four messages are required for a reliable acknowledgement operation. The identification request ident.req. contains the parameters of the second communication party 4 or 6 or 8. The first communication party 2 checks the values and sends the negotiable values back in the identification acknowledgement ident.ack. If the identification acknowledgement reply ident.arep. of the second communication party 4 or 6 or 8 is negative, communication is not possible. If this is applicable, however, the negotiated communication parties are already set. At the end of the identification phase, a switch is made to the configuration phase or to the data exchange phase, depending on what has been negotiated.

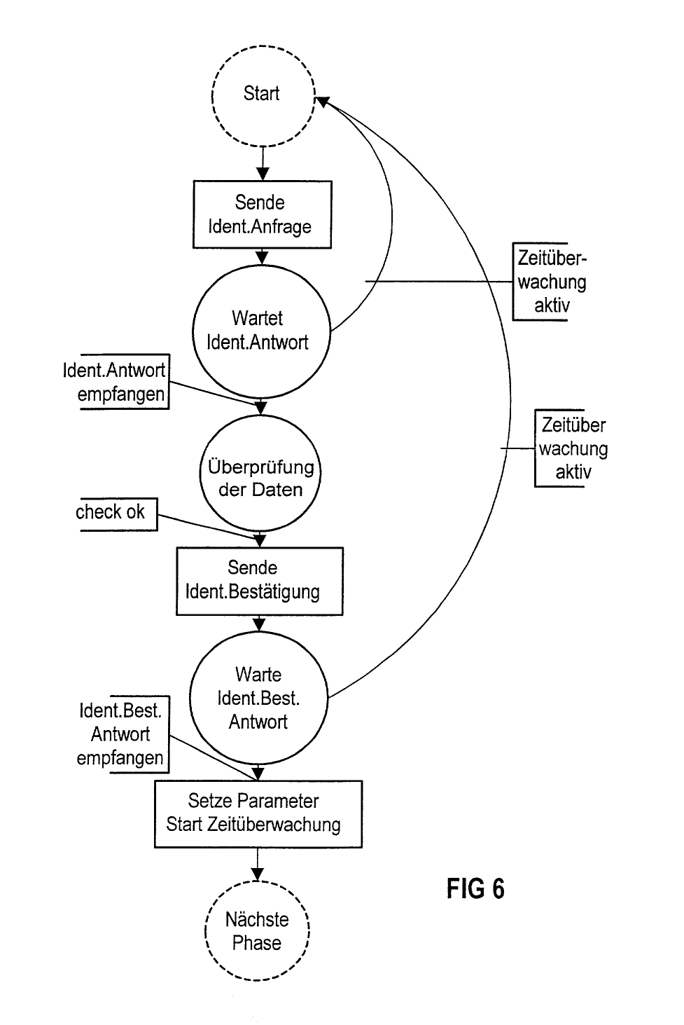

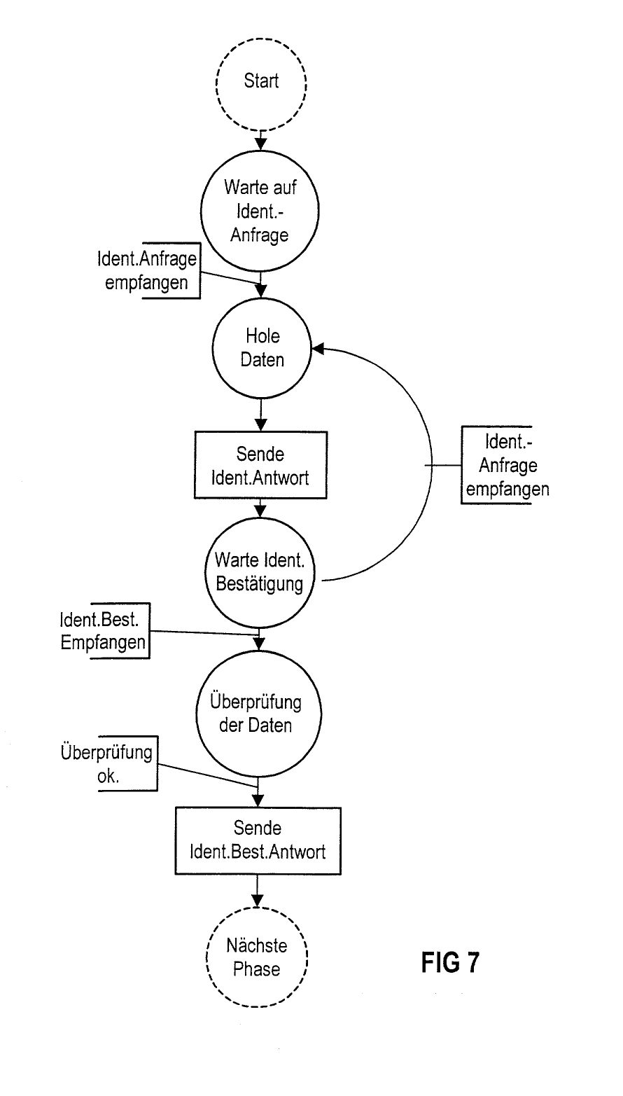

In FIGS. 6 and 7, the same identification phase of the communication method in accordance with the present invention as shown in FIG. 5 is in each case presented in a state diagram. The two state diagrams are presented from the viewpoint of the first and second communication parties 2, and 4 or 6 or 8, respectively. FIG. 6 shows the identification phase from the viewpoint of the first communication party 2, which is herein referred to as the master. In FIG. 7, the identification phase is presented from the viewpoint of the second communication party 4 or 6 or 8, which is herein referred to as the slave.

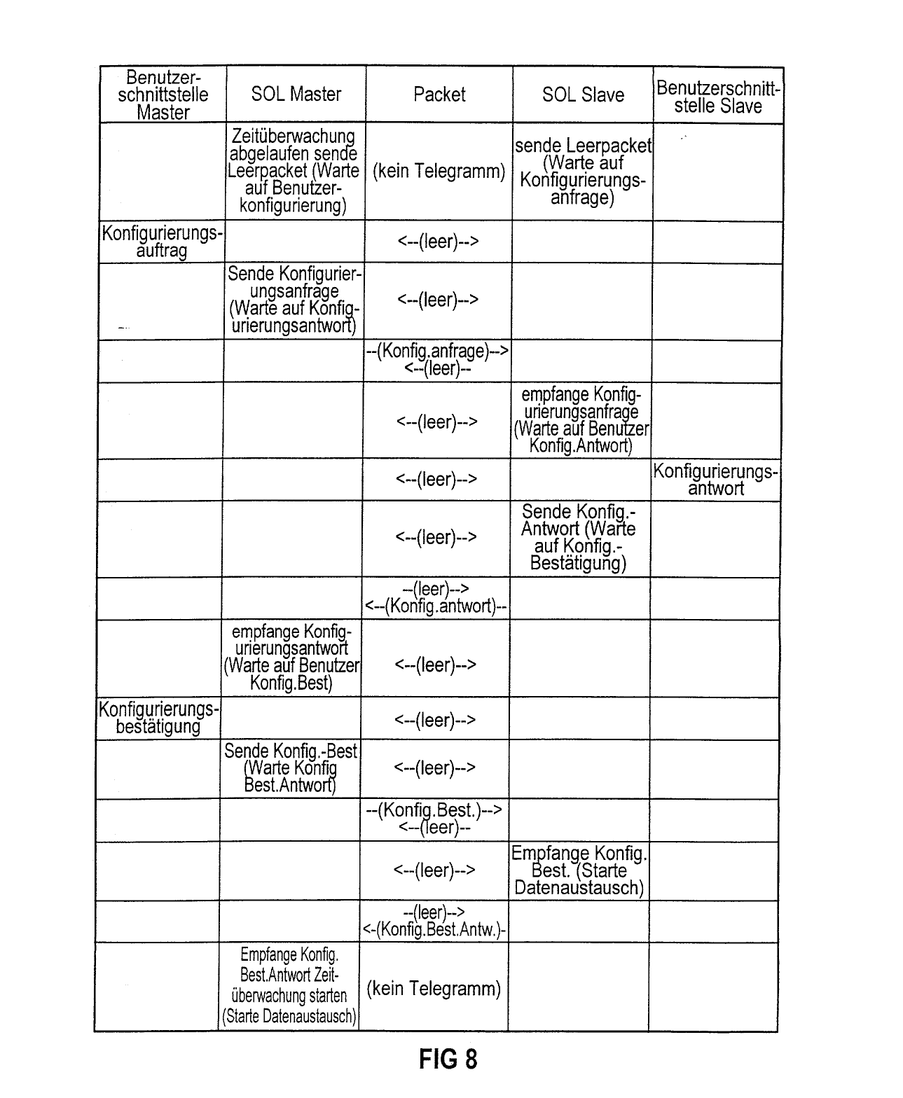

FIG. 8 shows a table of the transmission sequence of the messages of the configuration phase of the communication method in accordance with an exemplary embodiment of the present invention. During this configuration phase, configuration data is exchanged between the two communication parties 2, and 4 or 6 or 8. Also, in the configuration phase four messages are transmitted. These four messages are: a request message config.req., a reply message config.rep., an acknowledgement message config.ack. and an acknowledgement reply message config.arep. The request message config.req. and the reply message config.rep. comprise data. With these four messages, a reliable acknowledgement operation is carried out.

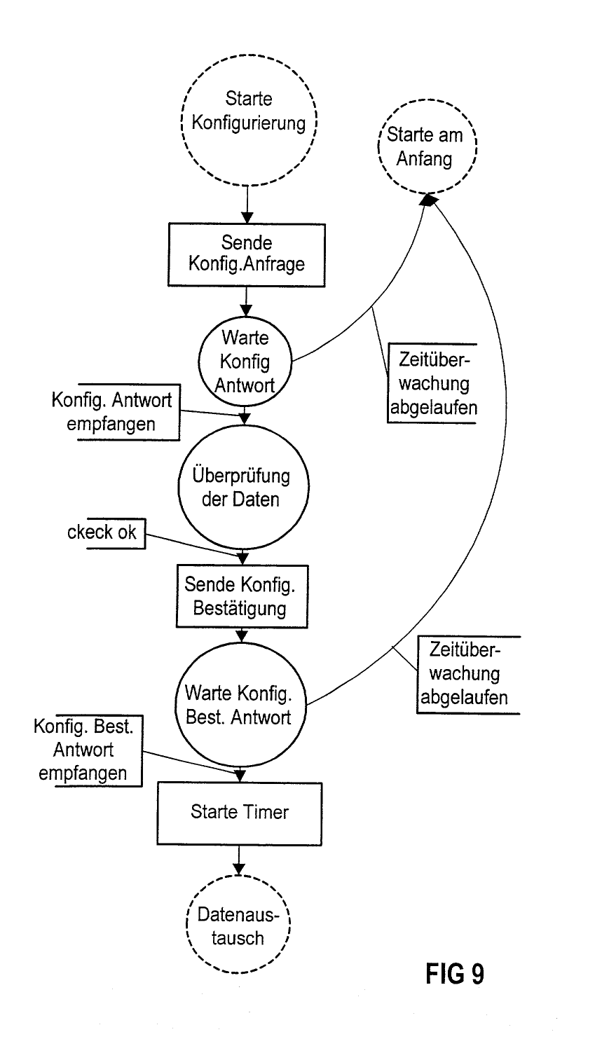

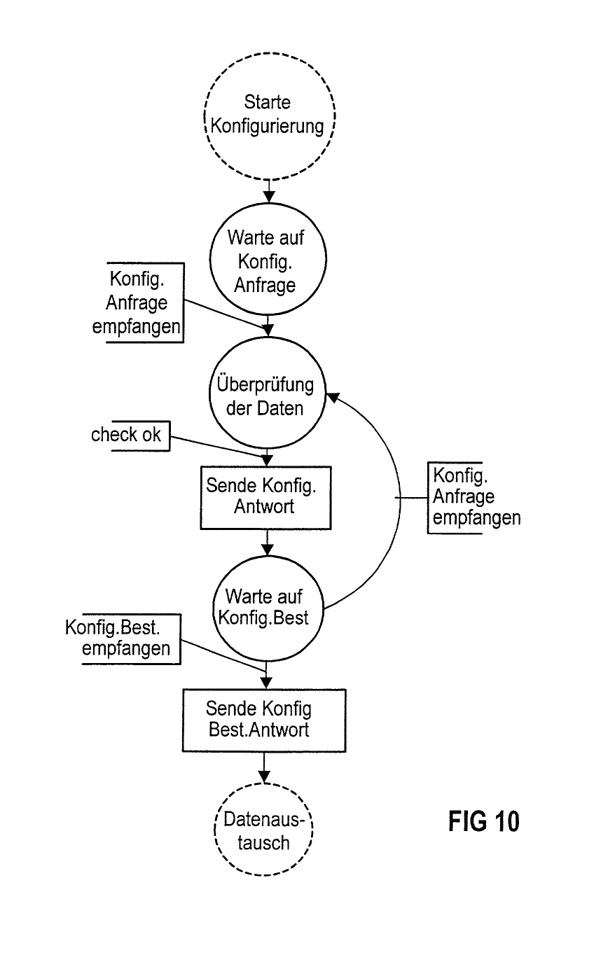

FIGS. 9 and 10 show two associated state diagrams of the configuration phase. FIG. 9 shows a state diagram from the viewpoint of the master (first communication party 2). FIG. 10 shows a state diagram from the viewpoint of the slave (second communication party 4 or 6 or 8).

At the beginning of the configuration phase, in accordance with FIG. 9, the master 2 sends a request message config.req. with configuration data to the slave 4 or 6 or 8 and waits for a reply message config.rep. from the slave 4 or 6 or 8. The configuration data of the request message config.req. is checked by the slave 4 or 6 or 8 and replied to immediately with a positive or negative reply message config.rep. The configuration data includes, inter alia, a bus address and a baud rate. If the reply is negative, the master 2 signals an error and requests the operator to change the configuration data. Once this has happened, a new request message is sent by the master 2. With the acknowledgement message config.ack., the master 2 will send a positive response to the configuration data sent back, which has been transmitted from the slave 4 or 6 or 8 to the master 2 by means of the reply message. The last message ensures the double acknowledgement operation. A time overrun during this phase leads to a new start of the identification phase.

At the beginning of the configuration phase, in accordance with FIG. 10, the slave 4 or 6 or 8 is expecting a configuration request config.req. Once the slave 4 or 6 or 8 has received this request config.req., the data is analyzed. Depending on this analysis, a positive or negative configuration reply config.rep. is sent. If the reply is negative, a new configuration is expected by means of the configuration request config.req. If the result of the analysis is positive, the data is sent back to the master 2 with the configuration reply. Thereafter, the slave 4 or 6 or 8 waits for a configuration acknowledgement config.ack. from the master 2. If the data is invalid, the configuration acknowledgement is negative. The acknowledgement reply config.arep. from the slave 4 or 6 or 8 is dependent on the data and on the type of slave 4 or 6 or 8. If a critical error is established in the data of the configuration acknowledgement reply config.arep., the configuration phase can be restarted. If no critical error can be established in the set of data, a switch is made to the phase of the data exchange.

In the data exchange phase, cyclical and acyclical data are exchanged between the two communication parties 2 and 4 or 6 or 8. A strict distinction is drawn between these two types of data, in order that the acyclical data cannot affect the cyclical data, which are processed in the high-speed time slice. The acyclical data is processed independently of the cyclical data. As soon as there is an error, the acyclical data communication is interrupted and the error message is transmitted with the acyclical data channel.

There are two reasons to leave the data exchange phase: (i) a new identification or configuration, which can be requested by means of the cyclical or acyclical channel; or (ii) loss of connection (If there is no valid message within a predetermined time, this is taken to be a loss of connection. This leads to a restart of the communication method, which begins with the identification phase).

For the communication between two communication parties 2, and 4 or 6 or 8 which are linked to each other by means of a full-duplex point-to-point connection 10, there are two data exchange channels, namely a cyclical channel and an acyclical channel for the reply of the second communication party 4 or 6 or 8.

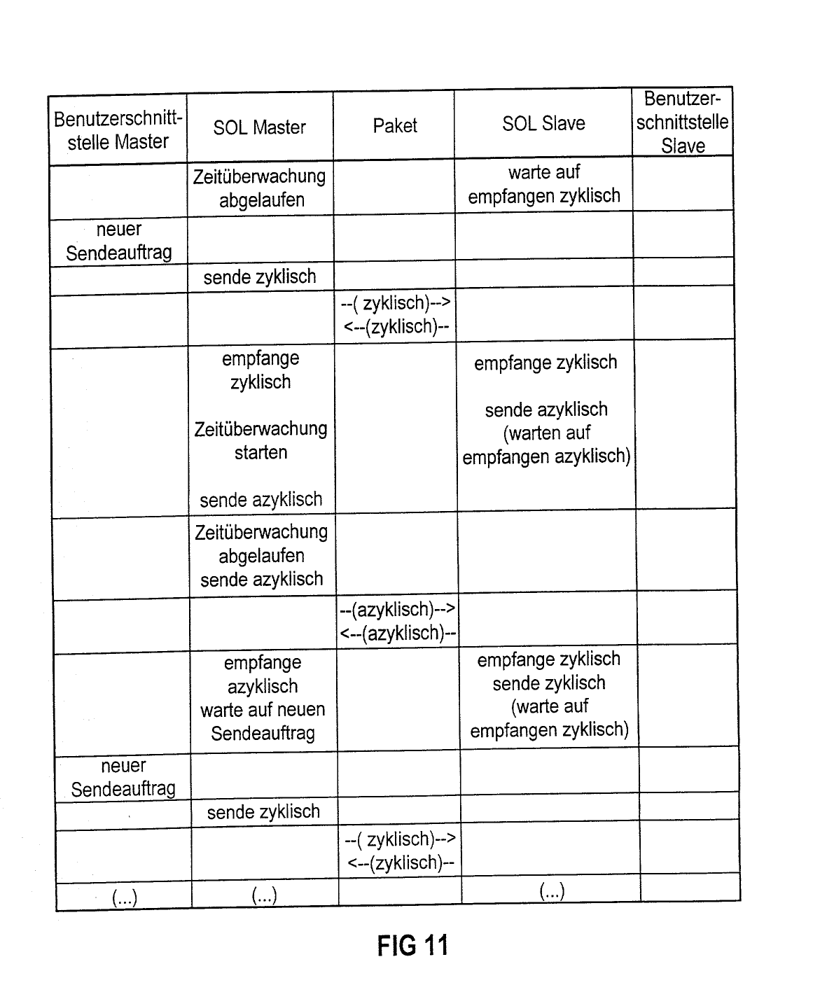

FIG. 11 shows a table of the transmission sequence of the messages of the data exchange with alternating cyclical and acyclical data. The first communication party 2 is also referred to here again as the master, whereas the second communication party 4 or 6 or 8 is referred to as the slave. The master user triggers the processing of the data exchange. All the other user calls are asynchronous.

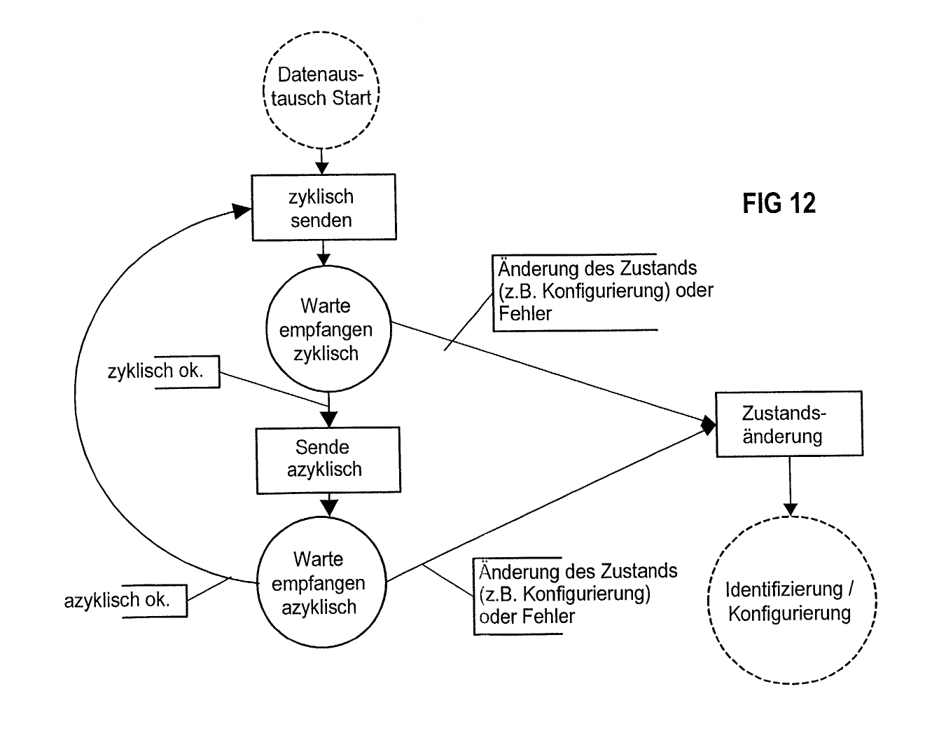

FIG. 12 illustrates in a state diagram the data exchange phase from the viewpoint of the master 2 and of the slave 4 or 6 or 8. The cyclical channel is very constant. Process data with a known significance are transmitted there. On the other hand, the acyclical channel is not constant, as discussed below.

The acyclical channel is based on the client/server principle, one of two communication parties sending a request to which the other communication party then replies. In principle, both communication parties can send requests, but the current method only allows requests from the second communication party 4 or 6 or 8 to the first communication party 2.

The following functions are performed by this communication mechanism:

Parameter request:

The client 2 sends a parameter request and the server 4 or 6 or 8 responds with a user reply. The parameter request/reply may be longer than an acyclical channel. If this is the case, domain handling must be carried out.

Alarm request:

The client 2 sends an alarm request and the server 4 or 6 or 8 responds as in the case of a parameter request with a user reply. The length of an alarm request/reply is fixed and can always be accommodated in an acyclical channel. An alarm request interrupts a domain transfer.

Diagnosis request:

The client 2 sends a diagnosis request and the server 4 or 6 or 8 responds with a reply. A diagnosis request is not answered by the user. The length of diagnostic data is fixed and they can always be accommodated in an acyclical channel.

In general, only one request is ever transmitted at a time. If a domain transfer is active, it is only interrupted by an alarm request. Data is only sent if there is a new request/reply. Otherwise, only substitute messages are sent.

Domain handling refers to a communication mechanism in which data is transmitted by means of a plurality of messages. This operation remains concealed from the user. This communication mechanism is used only for parameter data. All other data is accommodated in a message.

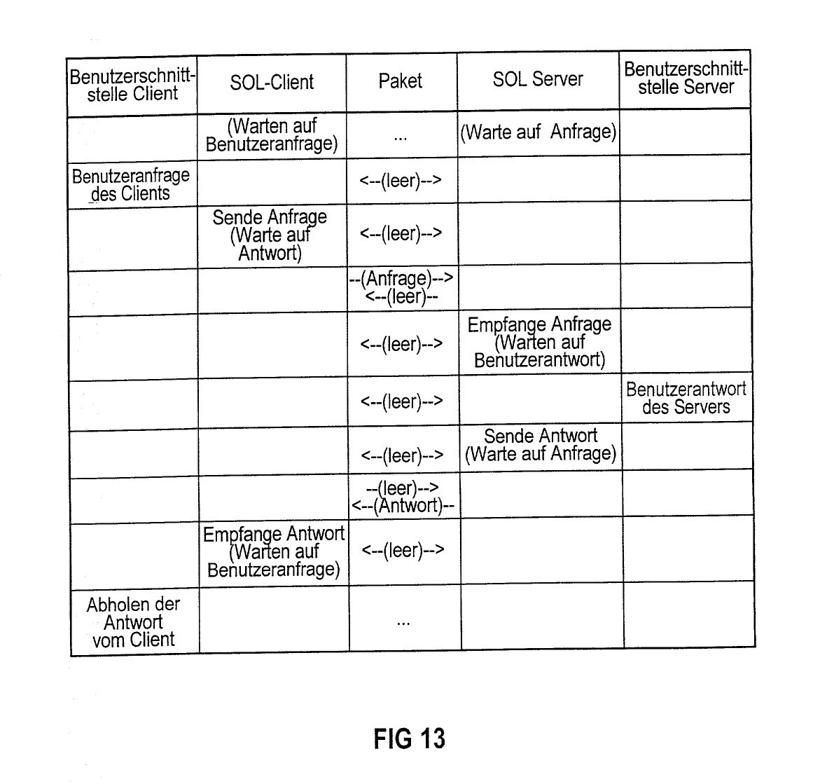

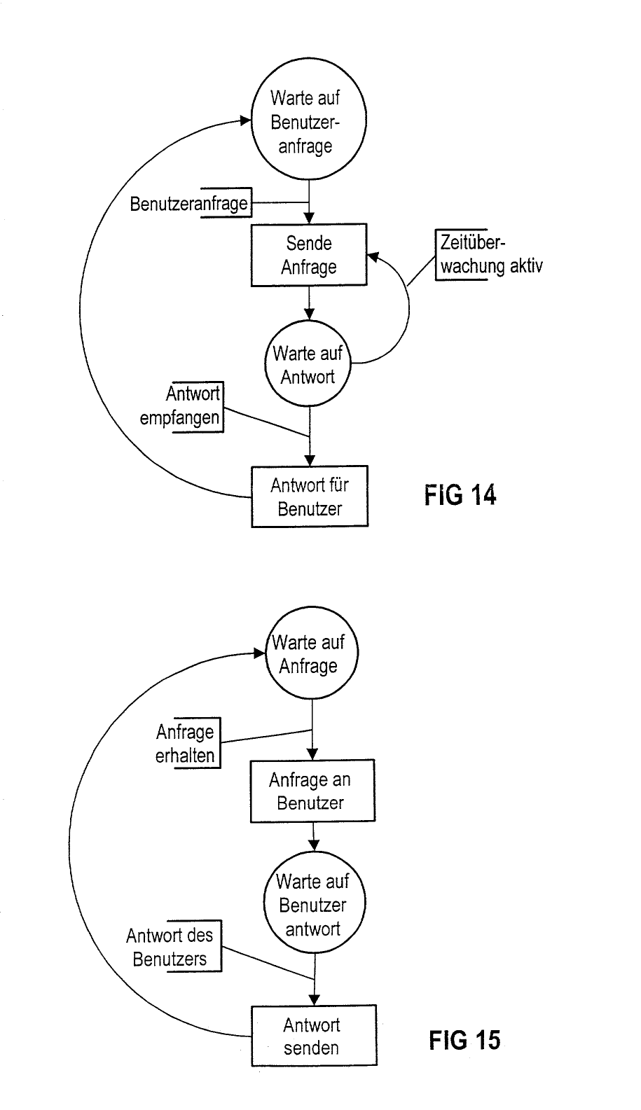

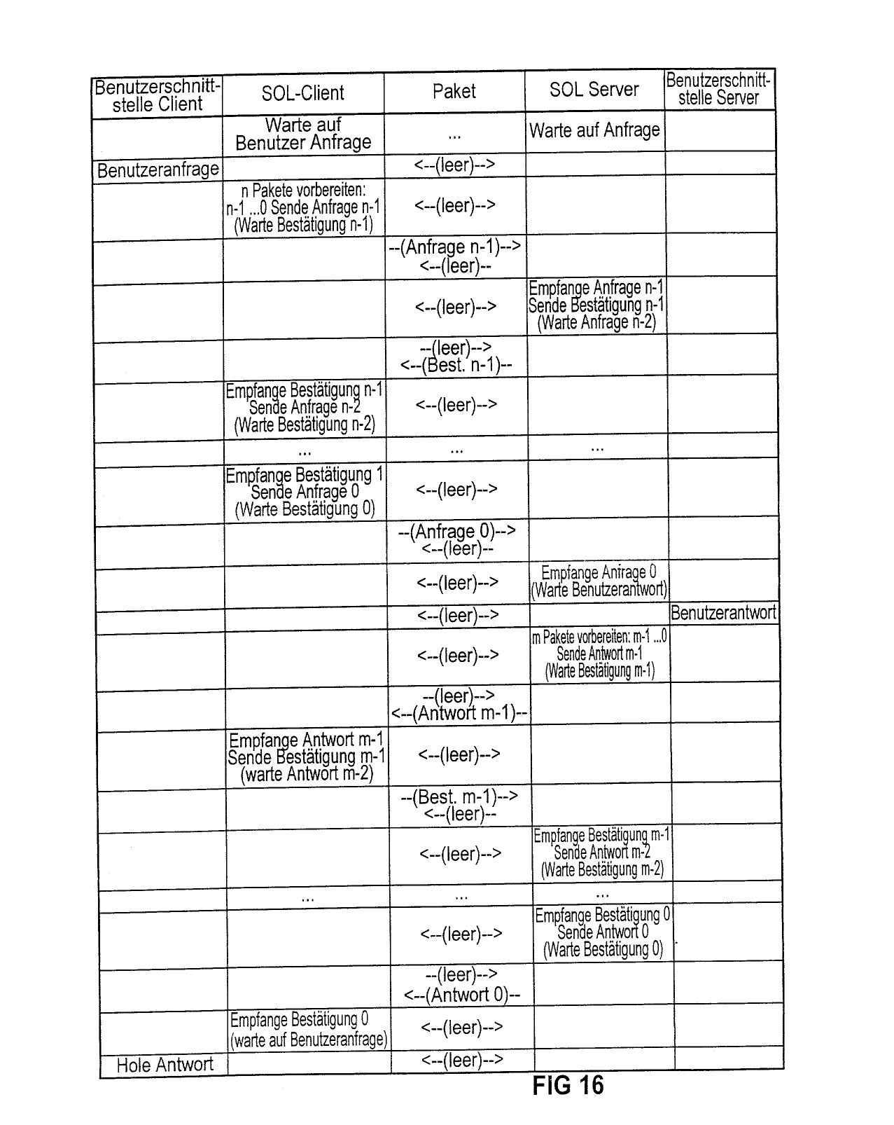

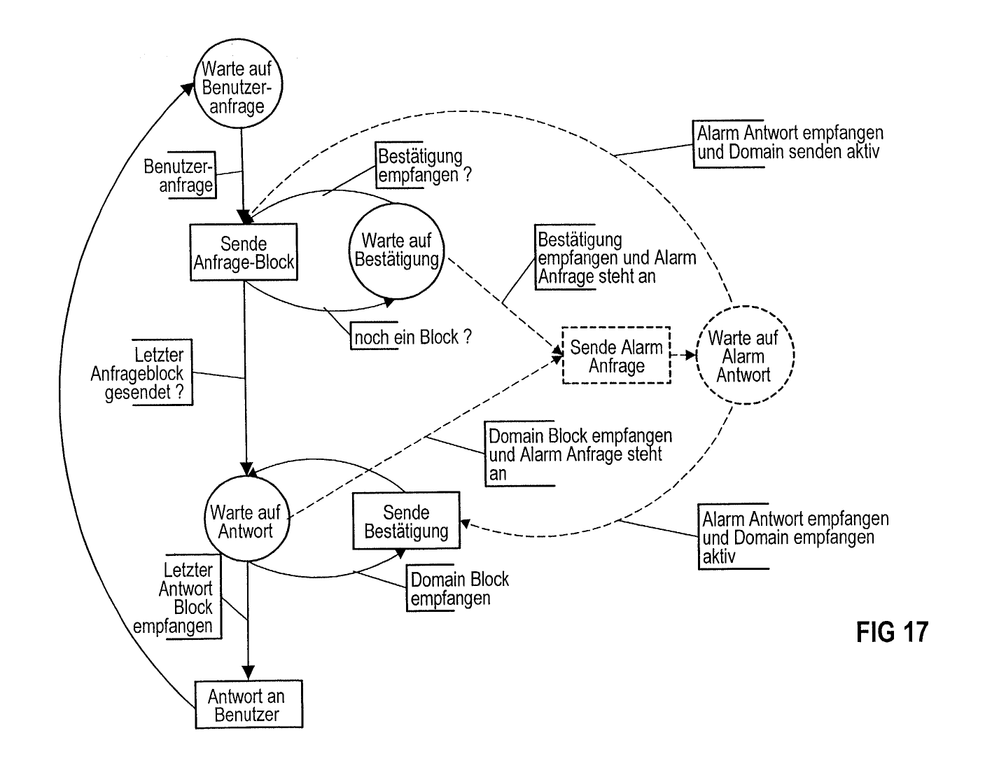

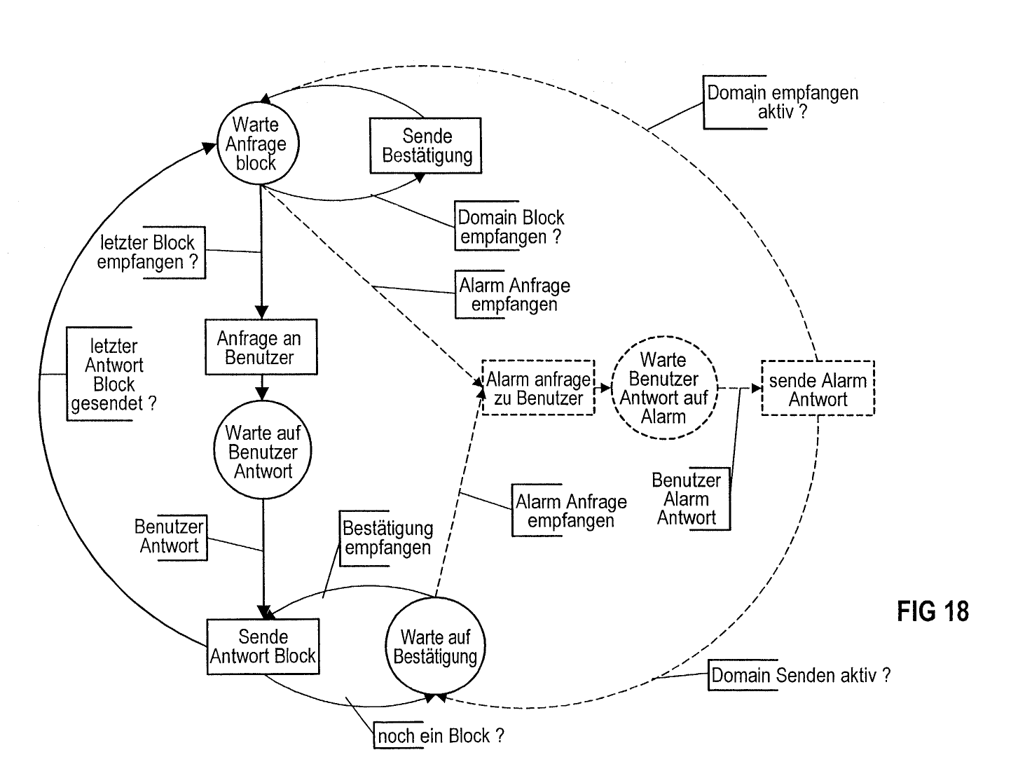

FIG. 13 shows in a table the transmission sequence of the messages of an acyclical data exchange without domain handling. In FIGS. 14 and 15, the associated state diagrams are presented in more detail from the viewpoint of the client 2 and of the server 4 or 6 or 8. For comparison, FIG. 16 shows a table of the transmission sequence of the messages of an acyclical data exchange with domain handling. The corresponding state diagrams from the viewpoint of the client 2 and of the server 4 or 6 or 8 are presented in more detail in FIGS. 17 and 18. FIGS. 17 and 18, the bold-printed lines show the normal sequence (no domain) and the interrupted lines show an alarm, which interrupts the domain handling.

If, according to the state diagram as shown in FIG. 17, the user initializes a request, the latter is sent. Thereafter, the user waits for a reply. If no reply arrives within a predetermined time, the request is repeated. An arriving reply is passed onto the user, wit the exception of a diagnosis reply is not passed on to the user.

If the data contain a domain request, the complete domain is sent. Each individual part of the domain is acknowledged separately by the receiver. If the complete domain request is sent without errors, the reply is expected. This reply is then sent by the receiver. If this reply contains a domain, each individual part of the domain is acknowledged. As soon as the complete reply has been received, it is processed and the method sequence starts again from the beginning. In the case of a time overrun or a domain error, the request is repeated.

In accordance with FIG. 18, a reply is sent after processing by the user if the processing channel is free and the received data is valid. If the data contain a domain request, the complete domain is received. Each part of the domain is acknowledged individually. As soon as the complete domain has been received and is valid, it is processed.

These communication mechanisms according to the present invention provide a fast periodic communication between two communication parties 2, and 4 or 6 or 8, in particular between a processor of a drive system and a processor of a module, which are linked to each other by means of a full-duplex point-to-point connection 10, the serial interfaces of the processor being used. Since the serial interfaces of two processors are used, no dual-port RAMs are required any longer, so that the method according to the present invention is advantageous specifically in the case of low-performance drive systems, because of a considerable cost advantage. Also, the acyclical data transmission does not destroy or influence the cyclical data exchange. Furthermore, the bandwidth of the transmission is scalable in dependence on the functionality and capabilities of the communication parties.

We claim:

1. A communication method for two communication parties linked to each other by means of a full-duplex point-to-point connection, said method comprising:
an identification phase wherein said communication parties identify themselves to one another and define communication parameters;
a configuration phase wherein communication-party-dependent configuration data is exchanged between said two communication parties; and
a data exchange phase wherein cyclical and acyclical data is exchanged between the said communication parties if the configuration phase has been successfully completed.

2. The communication method as claimed in claim 1, wherein said identification phase is preceded by an initialization phase during which a second communication party is recognized by a first communication party.

3. The communication method as claimed in claims 1 or 2, wherein said identification phase and said configuration phase each comprise a double acknowledgement operation.

4. The communication method as claimed in claims 1 or 2, wherein said configuration phase can recommence at any time.

5. The communication method as claimed in claims 1 or 2, wherein said configuration phase is skipped.

6. The communication method as claimed in claims 1 or 2, wherein an absent connection during a communication is restored by a restart of said identification phase.

7. The communication method as claimed in claims 1 or 2, wherein said data exchange phase has at least one channel.

8. The communication method as claimed in claims 1 or 2, wherein a first communication party comprises a converter and a second communication party comprises an option module.

9. The communication method as claimed in claim 8, wherein said option module comprises an automation module.

10. The communication method as claimed in claim 8, wherein said option module comprises a technology module.

11. The communication method as claimed in claim 2, wherein a voltage potential on a connecting line of said full-duplex point-to-point connection is evaluated for an identification of a second communication party.
